(19) United States
(12) Patent Application Publication
(10) Pub. No.: US 2024/0388206 A1
(43) Pub. Date: Nov. 21, 2024

(54) Multiple-Output Power Converter Circuit with Shared Capacitor

(71) Applicant: Apple Inc., Cupertino, CA (US)

(72) Inventors: Giovanni Saccomanno, Munich (DE); Michael Couleur, Rottach-Egern (DE); Bhanupriya Suresh, Munich (DE)

(21) Appl. No.: 18/320,978

(22) Filed: May 20, 2023

(51) Int. Cl. H02M 3/158; H02M 1/00; H02M 1/088; H02M 3/157

(52) U.S. Cl. CPC H02M 3/1582; H02M 1/0012; H02M 1/088; H02M 3/157

(57) ABSTRACT

A switching circuit for a single-input multiple-output power converter is disclosed. The switching circuit includes an inductor coupled between an input power supply and a switch node, which is further coupled to a shared capacitor. Multiple switch circuits generate, during different time periods, corresponding boost voltages using the shared capacitor. The boost voltages are used by the multiple switch circuits to couple the switch node to corresponding regulated power supply nodes.

### BACKGROUND

### Technical Field

This disclosure relates to power management in computer systems and, more particularly, to power converter circuit operation.

### Description of the Related Art

Modem computer systems may include multiple circuits blocks designed to perform various functions. For example, such circuit blocks may include processors and/or processor cores configured to execute software or program instructions. Additionally, the circuit blocks may include memory circuits, mixed-signal or analog circuits, and the like.

In some computer systems, the circuit blocks may be designed to operate at different power supply voltage levels. Power management circuits may be included in such computer systems to generate and monitor varying power supply voltage levels for the different circuit blocks.

Power management circuits often include one or more power converter circuits configured to generate regulated voltage levels on respective power supply signals using a voltage level of an input power supply signal. Such power converter circuits may employ multiple passive circuit elements such as inductors, capacitors, and the like.

### BRIEF DESCRIPTION OF THE DRAWINGS

FIG. 1 is a block diagram of an embodiment of a single-inductor multiple-output power switching circuit.

FIG. 2 is a block diagram of an embodiment of a switch circuit.

FIG. 3 is a block diagram of another embodiment of a switch circuit.

FIG. 4 is a block diagram of an embodiment of a level-shifter circuit.

FIG. 5 illustrates example waveforms associated with operating a single-inductor multiple-output power switching circuit.

FIG. 6 is a block diagram of an embodiment of a power converter circuit that uses a single-inductor multiple-output switching circuit.

FIG. 7 is a flow diagram of an embodiment of a method for operating a single-inductor multiple-output switching circuit for a power converter.

FIG. 8 is a block diagram of one embodiment of a system-on-a-chip that includes a power management circuit.

FIG. 9 is a block diagram of various embodiments of computer systems that may include single-inductor multiple-output power converter circuits.

FIG. 10 illustrates an example of a non-transitory computer-readable storage medium that stores circuit design information.

### DETAILED DESCRIPTION OF EMBODIMENTS

Computer systems may in lude multiple circuit blocks configured to perform specific functions. Such circuit blocks may be fabricated on a common substrate and may employ different power supply voltage levels. Power management units (referred to as “PMUs”) may include multiple voltage regulator or power converter circuits to generate regulated voltage levels for various power supply nodes within a computer system. Such voltage regulator and power converter circuits may employ both passive circuit elements (e.g., inductors, capacitors, etc.) as well as active circuit elements (e.g., transistors, diodes, etc.).

Different types of voltage regulator circuits may be employed based on power requirements of load circuits, available circuit area, and the like. One type of commonly used circuit is a buck power converter circuit (or simply a “buck converter circuit”). Buck converter circuits include multiple switches (also referred to as “power switches”) that are used to magnetize and de-magnetize an inductor in order to deliver power to a regulated power supply node.

One approach to generating different regulated voltage levels involves using multiple switches coupled between the output of a power converter circuit and respective power rails. This arrangement (referred to as “single-inductor multiple-output” or “SIMO”) delivers packets of charge to each rail from the power converter circuit in a round robin fashion.

In some cases, the voltage levels generated by a SIMO power converter circuit may be greater than a voltage level of an input power supply. Such power converter circuits may be referred to as “boost SIMO power converter circuits.” To allow for the greater output voltage levels greater than the voltage level of the input power supply, power switches need to be controlled by a voltage level that is also greater than the voltage level of the input power supply. To achieve the needed control voltages, a boost SIMO power converter circuit typically employs multiple boost capacitors to generate a boosted control voltage for each of the boost SIMO power converter circuit's outputs. Using multiple boost capacitors results in larger circuit area, as well as additional circuit complexity to control the multiple boost capacitors.

The embodiments described herein may provide techniques to reduce circuit complexity and circuit area for boost SIMO power converter circuits. By employing a single shared capacitor that is used by different switch driver circuits at different times to generate corresponding boost control voltages, both the circuit area overhead and the circuit complexity overhead associated with using multiple capacitors can be reduced.

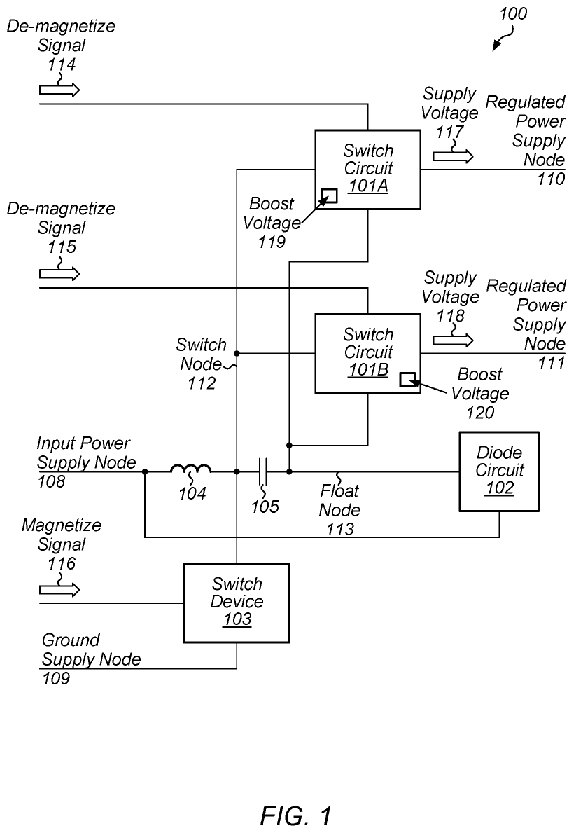

A block diagram of an embodiment of a single-inductor multiple-output power switching circuit is depicted in FIG. 1. As illustrated, switching circuit 100 includes switch circuits 101A and 101B, diode circuit 102, switch device 103, inductor 104, and capacitor 105.

Inductor 104 is coupled between input power supply node 108 and switch node 112. In various embodiments, inductor 104 may be implemented using a spiral or other suitable shape made from one or more layers of metal available on a semiconductor manufacturing process. In some cases, inductor 104 may be on a different integrated circuit than switch circuits 101A and 101B, diode circuit 102, and switch device 103.

Capacitor 105 is coupled between switch node 112 and float node 113. In various embodiments, capacitor 105 may be implemented using a metal-oxide-metal (MOM) structure, a metal-insulator-metal (MIM) structure, or any other suitable capacitor structure available on a semiconductor manufacturing process.

Switch device 103 is coupled to switch node 112 and ground supply node 109. In various embodiments, switch device 103 is configured to couple switch node 112 to ground supply node 109 in response to an activation of magnetize signal 116. In various embodiments, switch device 103 may be implemented using one or more transistors or other suitable switching circuit elements.

When switch node 112 is coupled to ground supply node 109, current flows from input power supply node 108 through inductor 104 into ground supply node 109, magnetizing inductor 104. As used herein, magnetizing an inductor refers to the process of increasing a current through the inductor to increase the magnetic field around the inductor.

Diode circuit 102 is coupled between float node 113 and input power supply node 108, and is configured to allow current to flow from input power supply node 108 to float node 113 when a voltage level of float node 113 is less than a voltage level of input power supply node 108. Diode circuit 102 is further configured to prevent current flowing from float node 113 into input power supply node 108 when the voltage level of float node 113 is greater than the voltage level of input power supply node 108. In various embodiments, diode circuit 102 may be implemented as a discrete PN junction structure or using a diode-connected field-effect transistor.

In addition to magnetizing inductor 104, the coupling of switch node 112 to ground supply node 109 also allows for current to flow from input power supply node 108, through diode circuit 102, into float node 113 to charge capacitor 105 to the voltage level of input power supply node 108.

When magnetize signal 116 is de-activated, switch device 103 is configured to de-couple switch node 112 from ground supply node 109. Once switch node 112 is de-coupled from ground supply node 109, the voltage level of switch node 112 increases as current flows from input power supply node 108 into switch node 112. The increase in the voltage level of switch node 112 is coupled into float node 113 across capacitor 105 causing the voltage level of float node 113 to increase above the voltage level of input power supply node 108. As described below, the increased voltage level of float node 113 can be used by either of switch circuits 101A or 101B to generate boost voltage levels used to control switch elements.

As magnetize signal 116 is de-activated, either of de-magnetize signals 114 or 115 will be activated, coupling one of regulated power supply nodes 110 or 111 to switch node 112. When this occurs, the magnetic field of inductor 104 begins to collapse, resulting in current flowing from switch node 112 to either of regulated power supply nodes 110 or 111 as inductor 104 de-magnetizes.

Switch circuit 101A is configured, in response to an activation of de-magnetize signal 114, to generate boost voltage 119 using capacitor 105. As described below, switch circuit 101A may include a level-shifter circuit configured to use the voltage level of float node 113 generated by capacitor 105 to generate boost voltage 119 based on de-magnetize signal 114. In various embodiments, switch circuit 101A is further configured, in response to the activation of de-magnetize signal 114, to couple switch node 112 to regulated power supply node 110 using boost voltage 119 to generate supply voltage 117.

Switch circuit 101B is configured, in response to an activation of de-magnetize signal 115, to generate boost voltage 120 using capacitor 105. As described below, switch circuit 101B may include a level-shifter circuit configured to use the voltage level of float node 113 generated by capacitor 105 to generate boost voltage 120 based on de-magnetize signal 115. In various embodiments, switch circuit 101B is further configured, in response to the activation of de-magnetize signal 115, to couple switch node 112 to regulated power supply node 111 using boost voltage 120 to generate supply voltage 118.

Although only two switch circuits are depicted in the embodiment of FIG. 1, in other embodiments, any suitable number of switch circuits may be employed. In some cases, the timing of de-magnetize signals 114 and 115, and magnetize signal 116 may be based on a number of switch circuits included in switching circuit 100. It is noted that only one switch circuit may be activated at any given time and that between activations of different switch circuits, magnetize signal 116 must be activated in order to magnetize inductor 104 and charge capacitor 105.

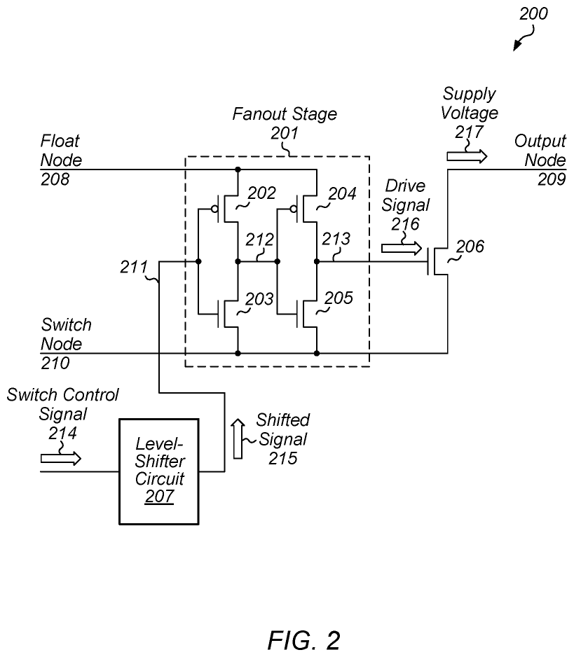

Turning to FIG. 2, a block diagram of an embodiment of a switch circuit is depicted. As illustrated, switch circuit 200 includes transistors 202-206, and level shifter circuit 207. In various embodiments, transistors 202-205 are included in fanout stage 201. It is noted that, in some embodiments, switch circuit 200 may correspond to either of switch circuits 101A or 101B.

Level shifter circuit 207 is configured to generate shifted signal 215 on node 211 using switch control signal 214. In various embodiments, switch control signal 214 may correspond to either of de-magnetization signals 114 or 115. Level shifter circuit 207 may be further configured to generate shifted signal 215, such that a voltage level of shifted signal 215 is greater than a voltage level of switch control signal 214.

Transistor 202 is coupled between float node 208 and node 212, while transistor 203 is coupled between node 212 and switch node 210. Both transistor 202 and transistor 203 are controlled by shifted signal 215. In some embodiments, float node 208 may correspond to float node 113, and switch node 210 may correspond to switch node 112. In various embodiments, transistors 202 and 203 are configured to function as an inverter circuit that generates a signal on node 212 that swings between the respective voltage levels of float node 208 and switch node 210. The signal generated on node 212 may, in various embodiments, have an opposite logical sense than shifted signal 215.

Transistor 204 is coupled between float node 208 and node 213, while transistor 205 is coupled between node 213 and switch node 210. Both transistor 204 and transistor 205 are controlled by a voltage level of node 212. In various embodiments, transistors 204 and 205 are configured to function as another inverter circuit that generates drive signal 216 on node 213 that swings between the respective voltage levels of float node 208 and switch node 210. Drive signal 216 may, in various embodiments, have an opposite logical sense than the signal generated on node 212 by transistors 202 and 203.

As described above, transistors 202 and 203 form a first inverter circuit, and transistors 204 and 205 form a second inverter circuit that is coupled in series with the first inverter circuit in fanout stage 201. In various embodiments, transistors 204 and 205 may have different physical and/or electrical characteristics than transistors 202 and 203. For example, transistors 204 and 205 may be manufactured with larger widths than transistors 202 and 203 in order to increase an amount of current the transistors can source and sink, respectively, to node 213. Although fanout stage 201 is depicted as including two inverters circuits, in other embodiments, fanout stage 201 may include additional transistors to form additional inverter circuits in order to provide sufficient drive strength for activating and de-activating transistor 206.

Transistor 206 is coupled between output node 209 and switch node 210, and is controlled by drive signal 216. In various embodiments, output node 209 may correspond to either of regulated power supply nodes 110 or 111. Transistor 206 is configured, in response to an activation of drive signal 216, to couple output node 209 to switch node 210, allowing current to flow from switch node 210 into output node 209. In various embodiments, the collapsing magnetic field of an inductor, e.g., inductor 104, as it is de-magnetized provides the electromotive force to cause the current to flow from switch node 210 to output node 209.

In various embodiments, transistors 202 and 204 may be implemented using p-channel metal-oxide semiconductor field-effect transistors (MOSFETs), fin field-effect transistors (FinFETs), gate-all-around field-effect transistors (GAAFETs), or any other suitable transconductance devices. Transistors 203, 205, and 206 may, in various embodiments, be implemented using n-channel MOSFETs, FinFETs, GAAFETs, or any other suitable transconductance devices. Although transistors 202-206 are depicted as being single transistors, in other embodiments, any of transistors 202-206 may be implemented using any suitable series and/or parallel combination of transistors.

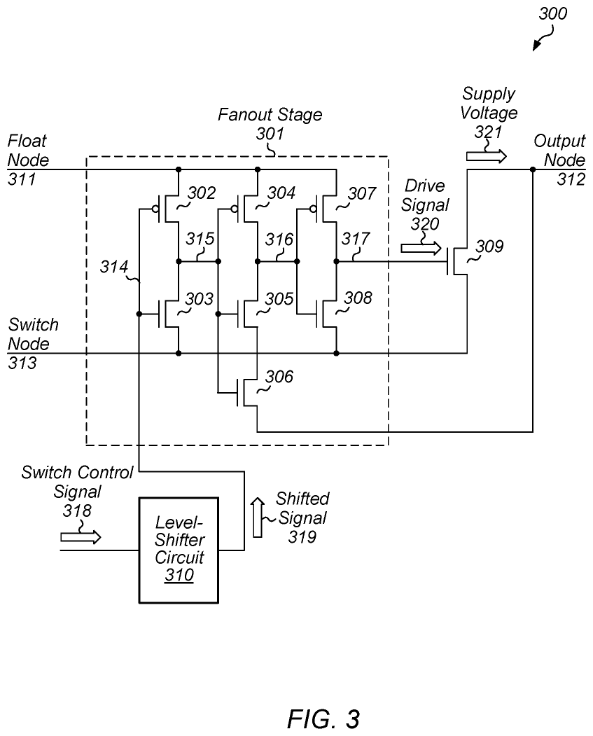

Turning to FIG. 3, a block diagram of another embodiment of a switch circuit is depicted. As illustrated, switch circuit 300 includes transistors 302-309, and level shifter circuit 310. In various embodiments, transistors 302-308 are included in fanout stage 301. It is noted that, in some embodiments, switch circuit 300 may correspond to either of switch circuits 101A or 101B.

Level shifter circuit 310 is configured to generate shifted signal 319 on node 314 using switch control signal 318. In various embodiments, switch control signal 318 may correspond to either of de-magnetization signals 114 or 115. Level shifter circuit 310 may be further configured to generate shifted signal 319 such that a voltage level of shifted signal 319 is greater than a voltage level of switch control signal 318.

Transistor 302 is coupled between float node 311 and node 315, while transistor 303 is coupled between node 315 and switch node 313. Both transistor 302 and transistor 303 are controlled by shifted signal 319. In some embodiments, float node 311 may correspond to float node 113, and switch node 313 may correspond to switch node 112. In various embodiments, transistors 302 and 303 are configured to function as an inverter circuit that generates a signal on node 315 that swings between the respective voltage levels of float node 311 and switch node 313. The signal generated on node 315 may, in various embodiments, have an opposite logical sense than shifted signal 319.

Transistor 304 is coupled between float node 311 and node 316, while transistor 305 is coupled between node 316 and transistor 306. Transistor 306 is coupled between transistor 305 and output node 312. Transistors 304, 305, and 306 are controlled by a voltage level of node 315. In various embodiments, transistors 304-306 are configured to function as another inverter circuit that generates a signal on node 316 that swings between the respective voltage levels of float node 311 and output node 312. By using output node 312, switch circuit 300 can operate in a quasi-adiabatic fashion, reusing a portion of the charge transferred to output node 312 to conserve energy.

Transistor 307 is coupled between float node 311 and node 317, while transistor 308 is coupled between node 317 and switch node 313. Both transistor 307 and transistor 308 are controlled by a voltage level of node 316. In various embodiments, transistors 307 and 308 are configured to function as another inverter circuit that generates drive signal 320 on node 317, where drive signal 320 swings between the respective voltage levels of float node 311 and switch node 313. Drive signal 320 may, in various embodiments, have an opposite logical sense than the signal generated on node 316.

As described above, transistors 302 and 303 form a first inverter circuit, transistors 304-306 form a second inverter circuit, and transistors 307 and 308 form a third inverter circuit that is coupled in series with the first and second inverter circuits in fanout stage 301. In various embodiments, transistors 304-306 may have different physical and/or electrical characteristics than transistors 302 and 303. For example, transistors 304-306 may be manufactured with larger widths than transistors 302 and 303 in order to increase an amount of current the transistors can source and sink, respectively, to node 316. In a similar fashion, transistors 307 and 308 may be manufactured with larger widths than transistors 304-306. Although fanout stage 301 is depicted as included three inverter circuits, in other embodiments, fanout stage 301 may include additional transistors to form additional inverter circuits in order to provide sufficient drive strength for activating and de-activating transistor 309. In various embodiments, a logical polarity of switch control signal 318 may be changed based on a number of inverter circuits included in fanout stage 301.

Transistor 309 is coupled between output node 312 and switch node 313, and is controlled by drive signal 320. In various embodiments, output node 312 may correspond to either of regulated power supply nodes 110 or 111. Transistor 309 is configured, in response to an activation of drive signal 320, to couple output node 312 to switch node 313, allowing current to flow from switch node 313 into output node 312. In various embodiments, the collapsing magnetic field of an inductor, e.g., inductor 104, as it is de-magnetized provides the electromotive force to cause the current to flow from switch node 313 to output node 312.

In various embodiments, transistors 302, 304, and 307 may be implemented using p-channel metal-oxide semiconductor field-effect transistors (MOSFETs), fin field-effect transistors (FinFETs), gate-all-around field-effect transistors (GAAFETs), or any other suitable transconductance devices. Transistors 303, 305, 306, 307, 308, and 309 may, in various embodiments, be implemented using n-channel MOSFETs, FinFETs, GAAFETs, or any other suitable transconductance devices. Although transistors 302-309 are depicted as being single transistors, in other embodiments, any of transistors 302-309 may be implemented using any suitable series and/or parallel combination of transistors.

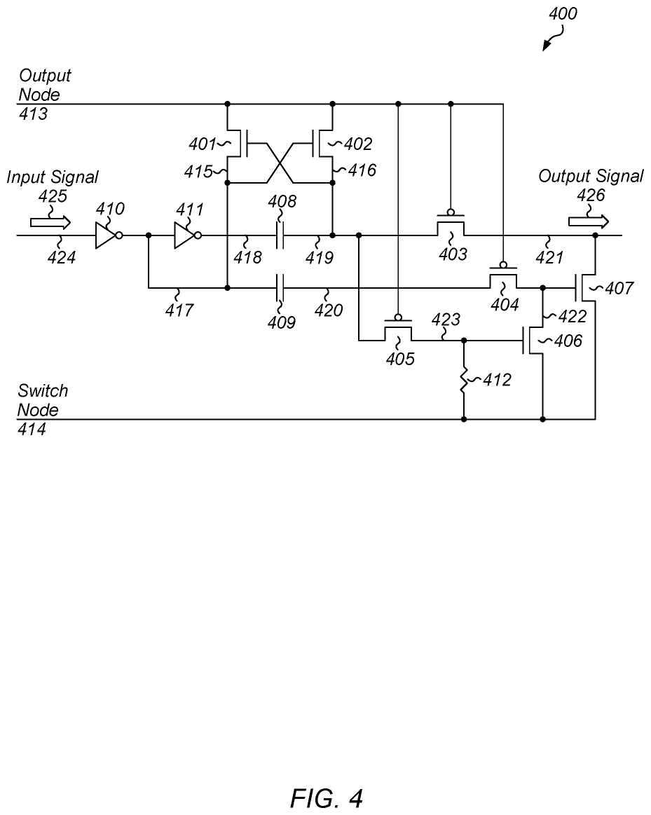

Turning to FIG. 4, a block diagram of a level-shifter circuit is depicted. As illustrated, level-shifter circuit 400 includes transistors 401-407, capacitors 408 and 409, inverters 410 and 411, and resistor 412. In some embodiments, level shifter circuit 400 may correspond to either of level-shifter circuit 207 or level-shifter circuit 310. In various embodiments, level-shifter circuit 400 is configured to generate output signal 426, which may correspond to either shifted signal 215 or shifted signal 319, using input signal 425. Output signal 426 may, in some embodiments, transition between the respective voltages of output node 413 and switch node 414, while input signal 425 may transition between the voltage level of input power supply node 108 and ground potential.

Transistor 401 is coupled between output node 413 and node 415, and is controlled by a voltage level of node 416. Transistor 402 is coupled between output node 413 and node 416, and is controlled by a voltage level of node 415. Transistors 401 and 402 can be referred to as being “cross-coupled” and they can provide regenerative feedback to maintain the voltage levels of at least one of nodes 415 and 416 at the voltage level of output node 413. In various embodiments, output node 413 may correspond to either of output node 209 or output node 312.

Inverter 410 is coupled between node 424 and node 417, and is configured to generate a signal on node 417 which is a logical inverse of input signal 425. In various embodiments, input signal 425 may correspond to either of switch control signal 214 or switch control signal 318. Inverter 411 is coupled between nodes 417 and 418, and is configured to generate a signal on node 418 that is a logical inverse of the signal on node 417. In various embodiments, inverters 410 and 411 may be implemented as CMOS inverters or any other suitable inverting amplifier circuit.

Capacitor 408 is coupled between node 418 and node 419, while capacitor 409 is coupled between node 417 and node 420. Capacitors 408 and 409 are configured to couple changes in the voltage levels of nodes 418 and 417 to nodes 419 and 420, respectively. In various embodiments, capacitors 408 and 409 may be implemented using a MOM structure, a MIM structure, or any other suitable capacitor structure available on a semiconductor manufacturing process.

Transistor 403 is coupled between node 419 and node 421, and is configured to couple node 419 to node 421 based on a voltage level of output node 413. In a similar fashion, transistor 404 is coupled between node 420 and node 422, and is configured to couple node 420 to node 422 based on the voltage level of output node 413.

Transistor 405 is coupled between node 419 and node 423, which is coupled to switch node 414 via resistor 412. Transistor 405 is configured to couple node 419 to node 423 based on the voltage level of output node 413. In various embodiments, switch node 414 may correspond to either of switch node 210 or switch node 313. Resistor 412 may be implemented using polysilicon, metal, or any other suitable material available on a semiconductor manufacturing process.

Transistor 406 is coupled between node 422 and switch node 414, and is configured to couple node 422 to switch node 414 based on a voltage level of node 423. Transistor 407 is coupled between node 421 and switch node 414, and is configured to coupled node 421 to switch node 414 based on a voltage level of node 422.

In various embodiments, transistors 403-405 may be implemented as p-channel MOSFETs, FinFETs, GAAFETs, or any other suitable transconductance devices, while transistors 401, 402, 406 and 407 may be implemented as n-channel MOSFETs, FinFETs, GAAFETs, or any other suitable transconductance devices. Although transistors 401-407 are depicted as single transistors, in other embodiments, any of transistors 401-407 may be implemented using any suitable parallel and/or series combination of transistors.

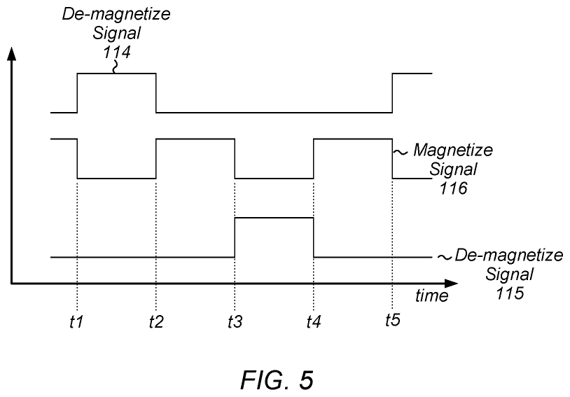

Turning to FIG. 5, example waveforms associated with operating a single-inductor multiple-output switching circuit are illustrated. In various embodiments, the waveforms may correspond to the operation of switching circuit 100 as depicted in FIG. 1.

At time t1, magnetize signal 116 transitions from a logical-1 value to a logical-0 value, ending a period of time during which inductor 104 is magnetized and capacitor 105 is charged. Also at time t1, de-magnetize signal 114 transitions from a logical-0 to a logical-1, starting a time period during which switch circuit 101A couples regulated supply node 110 to switch node 112.

At time t2, de-magnetize signal 114 transitions back to a logical-0, ending the period of time during which switch circuit 101A couples regulated supply node 110 to switch node 112. Also at time t2, magnetize signal 116 transitions back to a logical-1 value, starting a period of time during which inductor 104 is magnetized and capacitor 105 is charged.

At time t3, magnetize signal 116 transitions from a logical-1 value to a logical-0 value, ending the period of time during which inductor 104 is magnetized and capacitor 105 is charged. Also at time t3, de-magnetize signal 115 transitions from a logical-0 to a logical-1, starting a time period during which switch circuit 101B couples regulated supply node 111 to switch node 112.

At time t4, de-magnetize signal 115 transitions back to a logical-0, ending the period of time during which switch circuit 101B couples regulated supply node 111 to switch node 112. Also at time t4, magnetize signal 116 transitions back to a logical-1 value, starting another period of time during which inductor 104 is magnetized and capacitor 105 is charged.

At time t5, magnetize signal 116 transitions from a logical-1 value to a logical-0 value, ending the period of time during which inductor 104 is magnetized and capacitor 105 is charged. Also at time t5, de-magnetize signal 114 transitions from a logical-0 to a logical-1, starting another time period during which switch circuit 101A couples regulated supply node 110 to switch node 112.

Although only one complete cycle of supplying charge to regulated power supply nodes 110 and 111 is depicted in FIG. 5, in other embodiments, many cycles may be performed back-to-back.

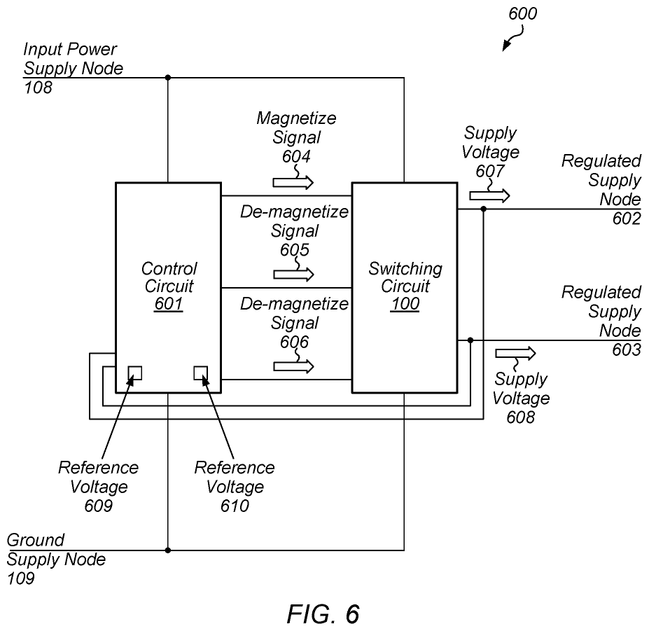

Turning to FIG. 6, a block diagram of an embodiment of a power converter circuit that uses a single-inductor multiple-output switching circuit is depicted. As illustrated, power converter circuit 600 includes switching circuit 100 and control circuit 601.

Switching circuit 100 is coupled to input power supply node 108, ground supply node 109, and regulated supply nodes 602 and 603, and is configured to generate supply voltages 607 and 608 on regulated supply nodes 602 and 603, respectively. In various embodiments, switching circuit 100 may be configured to operate as described above using magnetize signal 604, de-magnetize signal 605, and de-magnetize signal 606. In some embodiments, switching circuit 100 may be further configured to generate supply voltages 607 and 608 such that their respective values are greater than a voltage level of input power supply node 108.

Control circuit 601 is configured to generate magnetize signal 604, de-magnetize signal 605, and de-magnetize signal 606 using supply voltage 607, supply voltage 608, reference voltage 609, and reference voltage 610. In various embodiments, control circuit 601 may be configured to determine a duration of an active time of magnetize signal 605 based on a comparison of supply voltage 607 and reference voltage 609, or based on a comparison of supply voltage 608 and reference voltage 610. In other embodiments, control circuit 601 may be configured to determine a duration of an active time of de-magnetize signal 605 based on a comparison of supply voltage 607 and reference voltage 609. In some embodiments, control circuit 601 may be configured to determine a duration of de-magnetize signal 606 based on a comparison of supply voltage 608 and reference voltage 610.

In various embodiments, control circuit 601 may be implemented using any suitable combination of analog and digital circuits. In some cases, control circuit 601 may include multiple comparator circuits along with a state machine or other suitable sequential logic circuit.

To summarize, various embodiments of a power converter circuit are disclosed. Broadly speaking, a single-input multiple-output switching circuit includes an inductor coupled between an input power supply node and a switch node, a shared capacitor coupled to the switch node, and a switch device configured to couple the switch node to a ground supply node in response to an activation of a magnetize control signal. The switching circuit further includes a first switch circuit that may be configured, in response to an activation of a first de-magnetize signal, to generate a first boost voltage using the shared capacitor, and couple the switch node to a regulated power supply node using the first boost voltage. The switching circuit also includes a second switch circuit that may be configured, in response to an activation of a second de-magnetize signal, to generate a second boost voltage using the shared capacitor, and couple the switch node to a second regulated power supply node using the second boost voltage.

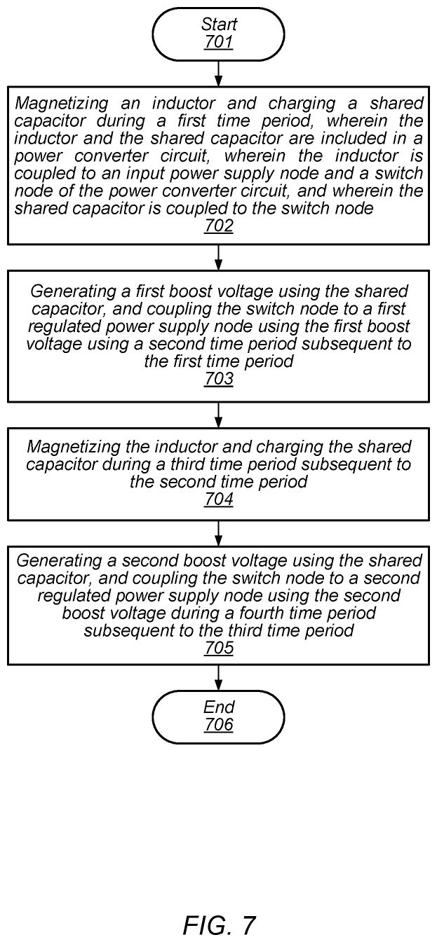

A flow diagram depicting an embodiment of a method for operating a power converter circuit is illustrated in FIG. 7. The method, which may be applied to various power converter circuits such as power converter circuit 600 as depicted in FIG. 6, begins in block 701.

The method includes magnetizing an inductor and a charging a shared capacitor during a first time period, where the inductor and the shared capacitor are included in a power converter circuit, where the inductor is coupled to an input power supply node and a switch node of the power converter circuit, and where the shared capacitor is coupled to the switch node (block 702). In some cases, the shared capacitor is further coupled to the input power supply node via a diode. In various embodiments, magnetizing the inductor includes coupling the switch node to a ground supply node.

The method further includes generating a first boost voltage using the shared capacitor, and coupling the switch node to a first regulated power supply node using the first boost voltage during a second time period subsequent to the first time period (block 703). In some embodiments, coupling the switch node to the first regulated power supply node includes translating a first voltage level of a first control signal using the first boosted voltage to generate a first shifted signal, and activating a switch device using the first shifted signal, where the first switch device is coupled between the switch node and the first regulated power supply node.

The method also includes magnetizing the inductor and charging the shared capacitor during a third time period subsequent to the second time period (block 704). In some embodiments, the method may further include determining a duration of the second time period using a first voltage level of the first regulated power supply node and a first reference voltage.

The method further includes generating a second boost voltage using the shared capacitor, and coupling the switch node to a second regulated power supply node using the second boost voltage during a fourth time period subsequent to the third time period (block 705). In some embodiments, coupling the switch node to the second regulated power supply node includes translating a second voltage level of a second control signal using the second boost voltage to generate a second shifted signal, and activating a second switch device using the second shifted signal, where the second switch device is coupled between the switch node and the second regulated power supply node.

In some embodiments, the method further includes determining a duration of the fourth time period using a second voltage level of the second regulated power supply node and a second reference voltage. The method concludes in block 706.

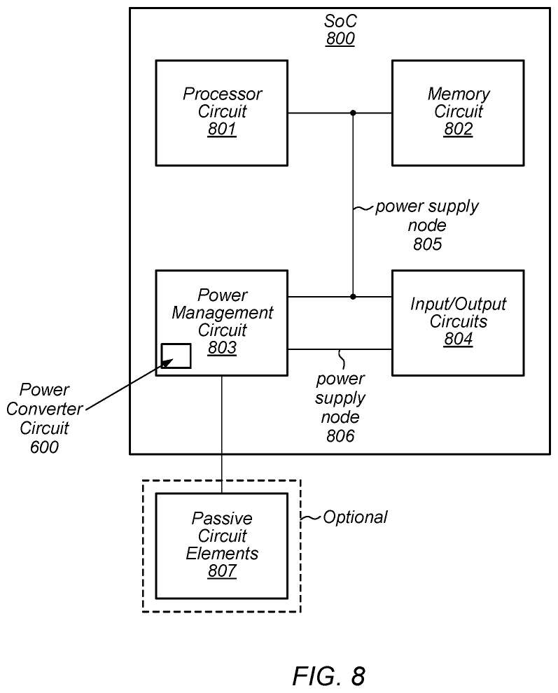

A block diagram of a system-on-a-chip (SoC) is illustrated in FIG. 8. In the illustrated embodiment, SoC 800 includes processor circuit 801, memory circuit 802, power management circuit 803, and input/output circuits 804. In various embodiments, SoC 800 may be configured for use in a desktop computer, server, or in a mobile computing application such as, e.g., a tablet, laptop computer, or wearable computing device.

Processor circuit 801 may, in various embodiments, be representative of a general-purpose processor that performs computational operations. For example, processor circuit 801 may be a central processing unit (CPU) such as a microprocessor, a microcontroller, an application-specific integrated circuit (ASIC), or a field-programmable gate array (FPGA).

Memory circuit 802 may, in various embodiments, include any suitable type of memory such as a Dynamic Random-Access Memory (DRAM), a Static Random-Access Memory (SRAM), a Read-Only Memory (ROM), an Electrically Erasable Programmable Read-only Memory (EEPROM), or a non-volatile memory, for example. It is noted that, although a single memory circuit is illustrated in FIG. 8, in other embodiments, any suitable number of memory circuits may be employed.

Power management circuit 803 includes power converter circuit 600, which is configured to generate respective voltage levels on power supply nodes 805 and 806 in order to provide power to processor circuit 801, memory circuit 802, and input/output circuits 804. Although power management circuit 803 is depicted as including a single power converter circuit, in other embodiments, any suitable number of power converter circuits may be included in power management circuit 803, each configured to generate regulated voltage levels on one or more power supply nodes included in SoC 800. In various embodiments, passive circuit elements 807, used by power converter circuit 600 may be optionally located on a different integrated circuit than SoC 800. In various embodiments, passive circuit elements 807 may include any suitable combination of inductors, capacitors, resistors, and the like.

Input/output circuits 804 may be configured to coordinate data transfer between SoC 800 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 804 may be configured to implement a version of Universal Serial Bus (USB) protocol or IEEE 1394 (Firewire®) protocol.

Input/output circuits 804 may also be configured to coordinate data transfer between SoC 800 and one or more devices (e.g., other computing systems or integrated circuits) coupled to SoC 800 via a network. In one embodiment, input/output circuits 804 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 804 may be configured to implement multiple discrete network interface ports.

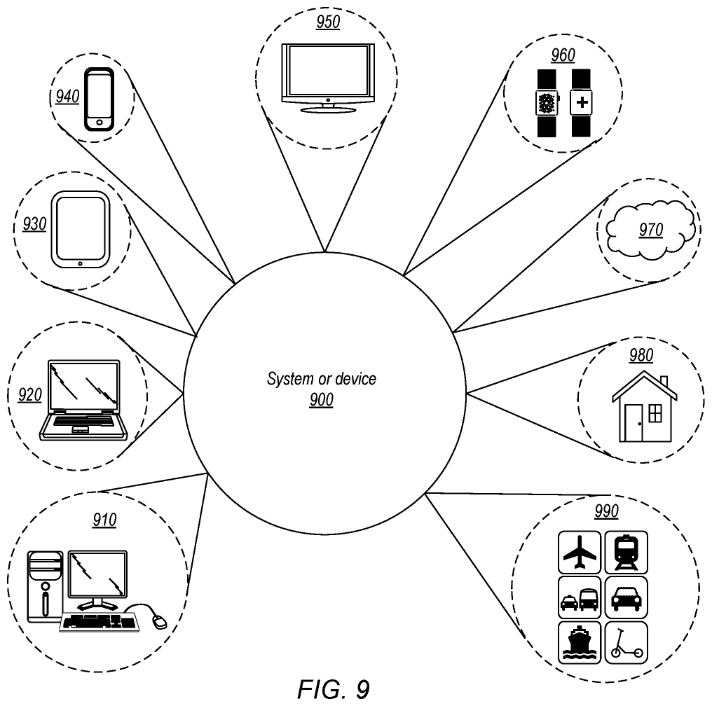

Turning now to FIG. 9, various types of systems that may include any of the circuits, devices, or systems discussed above are illustrated. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

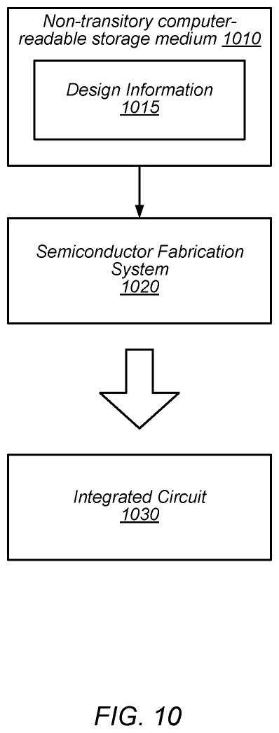

FIG. 10 is a block diagram illustrating an example of a non-transitory computer-readable storage medium that stores circuit design information, according to some embodiments. In the illustrated embodiment, semiconductor fabrication system 1020 is configured to process design information 1015 stored on non-transitory computer-readable storage medium 1010 and fabricate integrated circuit 1030 based on design information 1015.

Non-transitory computer-readable storage medium 1010 may comprise any of various appropriate types of memory devices or storage devices. Non-transitory computer-readable storage medium 1010 may be an installation medium, e.g., a CD-ROM, floppy disks, or tape device; a computer system memory or random-access memory such as DRAM, DDR RAM, SRAM, EDO RAM, Rambus RAM, etc.; a non-volatile memory such as Flash, magnetic media, e.g., a hard drive, or optical storage; registers, or other similar types of memory elements, etc. Non-transitory computer-readable storage medium 1010 may include other types of non-transitory memory as well or combinations thereof. Non-transitory computer-readable storage medium 1010 may include two or more memory mediums, which may reside in different locations, e.g., in different computer systems that are connected over a network.

Design information 1015 may be specified using any of various appropriate computer languages, including hardware description languages such as, without limitation: VHDL, Verilog, SystemC, SystemVerilog, RHDL, M, MyHDL, etc. Design information 1015 may be usable by semiconductor fabrication system 1020 to fabricate at least a portion of integrated circuit 1030. The format of design information 1015 may be recognized by at least one semiconductor fabrication system, such as semiconductor fabrication system 1020, for example. In some embodiments, design information 1015 may include a netlist that specifies elements of a cell library, as well as their connectivity. One or more cell libraries used during logic synthesis of circuits included in integrated circuit 1030 may also be included in design information 1015. Such cell libraries may include information indicative of device or transistor-level netlists, mask design data, characterization data, and the like, of cells included in the cell library.

Integrated circuit 1030 may, in various embodiments, include one or more custom macrocells, such as memories, analog or mixed-signal circuits, and the like. In such cases, design information 1015 may include information related to included macrocells. Such information may include, without limitation, schematics capture database, mask design data, behavioral models, and device or transistor-level netlists. As used herein, mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 is configured to operate according to a circuit design specified by design information 1015, which may include performing any of the functionality described herein. For example, integrated circuit 1030 may include any of various elements shown or described herein. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]-is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function]construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. An apparatus, comprising:
an inductor coupled between an input power supply node and a switch node;
a shared capacitor coupled to the switch node;
a switch device configured to couple the switch node to a ground supply node in response to an activation of a magnetize control signal;
a first switch circuit configured, in response to an activation of a first de-magnetize signal, to generate a first boost voltage using the shared capacitor, and couple the switch node to a first regulated power supply node using the first boost voltage; and
a second switch circuit configured, in response to an activation of a second de-magnetize signal, to generate a second boost voltage using the shared capacitor, and couple the switch node to a second regulated power supply node using the second boost voltage.

2. The apparatus of claim 1, wherein the first switch circuit includes:
a level-shift circuit configured to translate a first voltage level of the first de-magnetize signal using the first boost voltage to generate a first shifted signal; and
a switch device configured to couple the switch node and the first regulated power supply node using the first shifted signal.

3. The apparatus of claim 1, wherein the second switch circuit includes:
a level-shift circuit configured to translate a second voltage level of the second de-magnetize signal using the second boost voltage to generate a second shifted signal; and
a switch device configured to couple the switch node and the second regulated power supply node using the second shifted signal.

4. The apparatus of claim 1, further comprising a control circuit configured to:
activate the magnetize control signal during a first time period;
activate the first de-magnetize signal during a second time period subsequent to the first time period;
activate the magnetize control signal during a third time period subsequent to the second time period; and
activate the second de-magnetize signal during a fourth time period subsequent to the third time period.

5. The apparatus of claim 4, wherein the control circuit is further configured to:
determine a first duration of the second time period using a first voltage level of the first regulated power supply node and a first reference voltage; and
determine a second duration of the fourth time period using a second voltage level of the second regulated power supply node and a second reference voltage.

6. The apparatus of claim 1, further comprising a diode coupled between the shared capacitor and the input power supply node.

7. A method, comprising:
magnetizing an inductor and charging a shared capacitor during a first time period, wherein the inductor and capacitor are included in a power converter circuit, wherein the inductor is coupled to an input power supply node and a switch node of the power converter circuit, and wherein the shared capacitor is coupled to the switch node;
generating a first boost voltage using the shared capacitor and coupling the switch node to a first regulated power supply node using the first boost voltage during a second time period subsequent to the first time period;
magnetizing the inductor and charging the shared capacitor during a third time period subsequent to the second time period; and
generating a second boost voltage using the shared capacitor and coupling the switch node to a second regulated power supply node using the second boost voltage during a fourth time period subsequent to the third time period.

8. The method of claim 7, wherein magnetizing the inductor includes coupling the switch node to a ground supply node.

9. The method of claim 7, wherein coupling the switch node to the first regulated power supply node includes:
translating a first voltage level of a first control signal using the first boosted voltage to generate a first shifted signal; and
activating a first switch device using the first shifted signal, wherein the first switch device is coupled between the switch node and the first regulated power supply node.

10. The method of claim 9, wherein coupling the switch node to the second regulated power supply node includes:
translating a second voltage level of a second control signal using the second boost voltage to generate a second shifted signal; and
activating a second switch device using the second shifted signal, wherein the second switch device is coupled between the switch node and the second regulated power supply node.

11. The method of claim 7, further comprising determining a duration of the second time period using a first voltage level of the first regulated power supply node and a first reference voltage.

12. The method of claim 11, further comprising determining a duration of the fourth time period using a second voltage level of the second regulated power supply node and a second reference voltage.

13. The method of claim 7, wherein the shared capacitor is further coupled to the input power supply node via a diode.

14. An apparatus, comprising:
a first circuit block coupled to a first regulated power supply node;
a second circuit block coupled to a second regulated power supply node; and
a power converter circuit that includes an inductor coupled between an input power supply node and a switch node, and a shared capacitor coupled to the switch node, wherein the power converter circuit is configured to:
magnetize the inductor and charge the shared capacitor during a first time period;
during a second time period, generate a first boost voltage using the shared capacitor and couple, using the first boost voltage, the switch node to the first regulated power supply node to generate a first voltage on the first regulated power supply node, wherein the second time period subsequent to the first time period;
magnetize the inductor and charge the shared capacitor during a third time period is subsequent to the second time period; and
during a fourth time period, generate a second boost voltage using the shared capacitor and couple, using the second boost voltage, the switch node to the second regulated power supply node to generate a second voltage on the second regulated power supply node, wherein the fourth time period is subsequent to the third time period.

15. The apparatus of claim 14, wherein to magnetize the inductor, the power converter circuit is further configured to couple the switch node to a ground supply node.

16. The apparatus of claim 14, wherein the power converter circuit includes a first switch device coupled between the switch node and the first regulated power supply node, and wherein to couple the switch node to the first regulated power supply node, the power converter circuit is further configured to:
translate a first voltage level of a first control signal using the first boost voltage to generate a first shifted signal; and
activate the first switch device using the first shifted signal.

17. The apparatus of claim 16, wherein the power converter circuit includes a second switch device coupled between the switch node and the second regulated power supply node, and wherein to couple the switch node to the second regulated power supply node, the power converter circuit is further configured to:
translate a second voltage level of a second control signal using the second boost voltage to generate a second shifted signal; and
activate a second switch device using the second shifted signal.

18. The apparatus of claim 14, wherein the power converter circuit is further configured to determine a duration of the second time period using a first voltage level of the first regulated power supply node and a first reference voltage.

19. The apparatus of claim 14, wherein the power converter circuit is further configured to determine a duration of the fourth time period using a second voltage level of the second regulated power supply node and a second reference voltage.

20. The apparatus of claim 14, wherein the shared capacitor is further coupled to the input power supply node via a diode.
